(19) United States
(12) Patent Application Publication
(10) Pub. No.: US 2016/0095022 A1
(43) Pub. Date: Mar. 31, 2016

(54) METHOD, APPARATUS, AND SYSTEM FOR CONNECTING TO NETWORK

(71) Applicant: Huawei Device Co., Ltd., Shenzhen (CN)

(72) Inventors: Hui JIN, Beijing (CN); Guowei OUYANG, Beijing (CN); Qiang YI, Beijing (CN)

(21) Appl. No.: 14/958,881

(22) Filed: Dec. 3, 2015

Related U.S. Application Data
(63) Continuation of application No. PCT/CN2013/083507, filed on Sep. 13, 2013.

(51) Int. Cl. H04W 36/00; H04W 36/38; H04W 36/32; H04W 76/02

(52) U.S. Cl. CPC H04W 36/0055; H04W 76/023; H04W 36/38; H04W 36/32; H04W 88/04

(57) ABSTRACT

The present disclosure discloses a method, an apparatus, and a system for connecting to a network. Embodiments of the present disclosure include: sending, by an MME, a first message to a server; and receiving, by the MME, a second message sent by the server, where the second message is used to instruct the MME to perform a relay process, where the relay process specifically includes: acquiring a list of candidate relay UEs that relay the UE, and sending a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE.

### CROSS-REFERENCE TO RELATED APPLICATIONS

This application is a continuation of International Patent Application No. PCT/CN2013/083507, filed on Sep. 13, 2013, which is hereby incorporated by reference in its entirety.

### TECHNICAL FIELD

The present disclosure relates to the field of communications technologies, and in particular, to a method, an apparatus, and a system for connecting to a network.

### BACKGROUND

In a conventional mobile network, when user equipment (UE) is not located within a coverage area of a network, the UE cannot connect to the network. To solve a problem that UE cannot connect to a network when the UE is not located within a coverage area of the network, a solution is proposed in the prior art that when UE is not located within a coverage area of a network, the UE may connect to a relay terminal relay UE, and then, the UE connects to the network by using the relay UE, so as to transmit data. The relay UE has a function of providing a connection to a network for another UE that is not located within a coverage area of the network.

Specifically, the relay UE establishes a radio resource control (RRC) connection with a base station; after the relay UE attaches to the network, and a packet data network gateway (PGW) assigns an IPv6 address prefix to the relay UE, the relay UE sends, to the UE, a message that carries an identity (ID) of the relay UE, so that the UE actively connects to the relay UE. After the UE connects to the relay UE, the relay UE assigns an IP address to the UE, thereby implementing that the UE that is not located within the coverage area of the network can connect to the network.

However, when UE is not located within a coverage area of a network or does not actively initiate a connection to the network, if a network side needs to send data to the UE, a normal transmission process cannot be performed to transmit the data. There is no solution to such a problem in the prior art.

### SUMMARY

Embodiments of the present disclosure provide a method, an apparatus, and a system for connecting to a network, which are used to solve a problem how a network side actively initiates a process of enabling UE that is not located within a coverage area of a network to connect to the network.

According to a first aspect, an embodiment of the present disclosure provides a method for connecting to a network, including:

sending, by a mobility management entity MME, a first message to a server, where the first message is used to notify the server that UE loses a connection to a network; and

receiving, by the MME, a second message sent by the server, where the second message is used to instruct the MME to perform a relay process, where

the relay process specifically includes:

acquiring, by the MME, a list of candidate relay UEs that relay the UE; and

sending, by the MME, a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE.

With reference to the first aspect, in a first possible embodiment, the acquiring, by the MME, a list of candidate relay UEs that relay the UE includes:

acquiring, by the MME, an identity ID of candidate relay UE that is located in a same cell as the UE and that relays the UE, and/or an ID of candidate relay UE that is located in a neighboring cell of a cell in which the UE is located and that relays the UE; and

generating, by the MME, the list of candidate relay UEs, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE.

With reference to the first aspect, in a second possible embodiment, the first message includes a cell ID of the UE, and the second message includes the list of candidate relay UEs that relay the UE; and

the acquiring, by the MME, a list of candidate relay UEs that relay the UE includes:

acquiring, by the MME, the list of candidate relay UEs from the second message.

With reference to any one of the foregoing possible embodiments of the first aspect, in a third possible embodiment, after the sending, by the MME, a third message to candidate relay UE in the list, the method further includes:

receiving, by the MME, a fifth message that carries an ID of the selected relay UE and that is sent by the server, where the fifth message is used to instruct the MME to send a sixth message to candidate relay UE except the selected relay UE in the list of candidate relay UEs, and the sixth message is used to instruct the candidate relay UE except the selected relay UE in the list of candidate relay UEs to stop sending the fourth message to the UE.

With reference to any one of the foregoing possible embodiments of the first aspect, in a fourth possible embodiment, before the sending, by a mobility management entity MME, a first message to the server, the method further includes:

receiving, by the MME, a seventh message that carries instruction information and that is sent by a base station, where the seventh message is used to notify the MME that the UE loses a connection to a network, and the instruction information is used to instruct the MME to report to the server that the UE loses a connection to a network; or

receiving, by the MME, a subscription request sent by the server, where the subscription request is a request for the server to subscribe to a state, of losing a connection to a network, of the UE.

According to a second aspect, an embodiment of the present disclosure provides another method for connecting to a network, including:

receiving, by user equipment UE, a fourth message sent by candidate relay UE in a list of candidate relay UEs, where the fourth message is used by the UE to determine selected relay UE and connect to a network by using the selected relay UE;

determining, by the UE, selected relay UE from candidate relay UEs corresponding to received fourth messages; and

connecting, by the UE, to a network by using the selected relay UE.

With reference to the second aspect, in a first possible embodiment, after the connecting, by the UE, to a network by using the selected relay UE, the method further includes:

sending, by the UE to a server, an eighth message that carries an identity ID of the selected relay UE, where the eighth message is used to notify the server that the UE has connected to a network.

With reference to the second aspect or the first possible embodiment of the second aspect, in a second possible embodiment, an identity ID of the UE is carried in the fourth message, and the determining, by the UE, selected relay UE from candidate relay UEs corresponding to received fourth messages includes:

determining, by the UE, the selected relay UE according to the ID of the UE that is carried in the received fourth messages.

According to a third aspect, an embodiment of the present disclosure provides another method for connecting to a network, including:

receiving, by a server, a first message sent by a mobility management entity MME, where the first message is used to notify the server that UE loses a connection to a network; and

sending, by the server, a second message to the MME when determining that the UE needs to connect to a network by using relay UE, where the second message is used to instruct the MME to perform a relay process.

With reference to the third aspect, in a first possible embodiment, before the sending, by the server, a second message to the MME when determining that the UE needs to connect to a network by using relay UE, the method further includes:

generating, by the server, a list of candidate relay UEs; and

the sending, by the server, a second message to the MME when determining that the UE needs to connect to a network by using relay UE includes:

sending, by the server to the MME when determining that the UE needs to connect to the network by using the relay UE, the second message that carries the list of candidate relay UEs.

With reference to the first possible embodiment of the third aspect, in a second possible embodiment, the first message includes a cell identity ID of the UE, and the generating, by the server, a list of candidate relay UEs includes:

sending, by the server, an acquiring request to a gateway mobile location center GMLC, where the acquiring request includes an ID and the cell ID of the UE;

receiving, by the server, a request reply message sent by the GMLC, where the request reply message includes an ID of candidate relay UE that is located in a same cell as the UE and that relays the UE, and/or an ID of candidate relay UE that is located in a neighboring cell of a cell in which the UE is located and that relays the UE; and

generating, by the server, the list of candidate relay UEs according to content of the request reply message, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE.

With reference to any one of the foregoing possible embodiments of the third aspect, in a third possible embodiment, after sending, by the server, the second message to the MME according to content of the first message, the method further includes:

receiving, by the server after the UE connects to a network, an eighth message that carries an ID of a selected relay UE and is sent by the UE, where the eighth message is used to notify the server that the UE has connected to a network; and

sending, by the server to the MME, a fifth message that carries the ID of the selected relay UE, where the fifth message is used to instruct the MME to send a sixth message to UE except the selected relay UE in the list of candidate relay UEs, and the sixth message is used to instruct the UE except the selected relay UE in the list of candidate relay UEs to stop sending a fourth message to the UE.

With reference to any one of the foregoing possible embodiments of the third aspect, in a fourth possible embodiment, before the receiving, by a server, a first message sent by a mobility management entity MME, the method further includes:

sending, by the server, a subscription request to the MME, where the subscription request is a request for the server to subscribe to a state, of losing a connection to a network, of the UE.

According to a fourth aspect, an embodiment of the present disclosure provides an apparatus for connecting to a network, including:

a sending module, configured to send a first message to a server, where the first message is used to notify the server that the UE loses a connection to a network;

a receiving module, configured to receive a second message sent by the server, where the second message is used to instruct an acquiring module and the sending module to perform a relay process; and

the acquiring module, configured to acquire a list of candidate relay UEs that relay the UE, where

the sending module is further configured to send a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE.

With reference to the fourth aspect, in a first possible embodiment, the acquiring module includes:

an acquiring unit, configured to acquire an identity ID of candidate relay UE that is located in a same cell as the UE and that relays the UE, and/or an ID of candidate relay UE that is located in a neighboring cell of a cell in which the UE is located and that relays the UE, and provide an acquiring result for a generating unit; and

the generating unit, configured to generate the list of candidate relay UEs according to the acquiring result provided by the acquiring unit, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE.

With reference to the fourth aspect, in a second possible embodiment, the first message includes a cell ID of the UE, and the second message includes the list of candidate relay UEs that relay the UE; and

the acquiring module is further configured to acquire the list of candidate relay UEs from the second message.

With reference to any one of the foregoing possible embodiments of the fourth aspect, in a third possible embodiment, the receiving module is further configured to receive a fifth message that carries an ID of the selected relay UE and that is sent by the server, where the fifth message is used to instruct the sending module to send a sixth message to candidate relay UE except the selected relay UE in the list of candidate relay UEs, and the sixth message is used to instruct the candidate relay UE except the selected relay UE in the list of candidate relay UEs to stop sending the fourth message to the UE; and

the sending module is further configured to send the sixth message to the candidate relay UE except the selected relay UE in the list of candidate relay UEs.

With reference to any one of the foregoing possible embodiments of the fourth aspect, in a fourth possible embodiment, the receiving module is further configured to receive a seventh message that carries instruction information and that is sent by a base station, where the seventh message is used to notify the apparatus that the UE loses a connection to a network, and the instruction information is used to instruct the sending module to report to the server that the UE loses a connection to a network; and

the receiving module is further configured to receive a subscription request sent by the server, where the subscription request is a request for the server to subscribe to a state, of losing a connection to a network, of the UE.

According to a fifth aspect, an embodiment of the present disclosure provides another apparatus for connecting to a network, including:

a receiving module, configured to receive a fourth message sent by candidate relay UE in a list of candidate relay UEs, and provide the fourth message for a determining module, where the fourth message is used by the determining module to determine selected relay UE and by a connecting module to connect to a network by using the selected relay UE;

the determining module, configured to determine selected relay UE from candidate relay UEs corresponding to received fourth messages, and provide an identity ID of the selected relay UE for the connecting module; and

the connecting module, configured to connect to a network by using the selected relay UE.

With reference to the fifth aspect, in a first possible embodiment,

the sending module is further configured to send, to a server, an eighth message that carries the ID of the selected relay UE, where the eighth message is used to notify the server that the connecting module has connected to a network.

With reference to the fifth aspect or the first possible embodiment of the fifth aspect, in a second possible embodiment, an identity ID of the apparatus is carried in the fourth message; and

the determining module is further configured to determine the selected relay UE according to the ID of the apparatus that is carried in the received fourth messages.

According to a sixth aspect, an embodiment of the present disclosure provides another apparatus for connecting to a network, including:

a receiving module, configured to receive a first message sent by a mobility management entity MME, and provide the first message for a judging module, where the first message is used to notify the apparatus that UE loses a connection to a network;

the judging module, configured to determine whether the UE needs to connect to a network by using relay UE, and provide a result of the determining for a sending module; and

the sending module, configured to send a second message to the MME when the result of the determining is that the UE needs to connect to the network by using the relay UE, where the second message is used to instruct the MME to perform a relay process.

With reference to the sixth aspect, in a first possible embodiment, the apparatus further includes:

a processing module, configured to generate a list of candidate relay UEs, where

the sending module is further configured to, when it is determined that the UE needs to connect to the network by using the relay UE, send, to the MME, the second message that carries the list of candidate relay UEs.

With reference to the first possible embodiment of the sixth aspect, in a second possible embodiment, the first message includes a cell identity ID of the UE, and the processing module includes:

a sending unit, configured to send an acquiring request to a gateway mobile location center GMLC, where the acquiring request includes an ID and the cell ID of the UE;

a receiving unit, configured to receive a request reply message sent by the GMLC, and provide the request reply message for a generating unit, where the request reply message includes an ID of candidate relay UE that is located in a same cell as the UE and that relays the UE, and/or an ID of candidate relay UE that is located in a neighboring cell of a cell in which the UE is located and that relays the UE; and

the generating unit, configured to generate the list of candidate relay UEs according to content of the request reply message, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE.

With reference to any one of the foregoing possible embodiments of the sixth aspect, in a third possible embodiment, the receiving module is further configured to, after the UE connects to a network, receive an eighth message that carries an ID of a selected relay UE and is sent by the UE, where the eighth message is used to notify the apparatus that the UE has connected to a network; and

the sending module is further configured to send, to the MME, a fifth message that carries the ID of the selected relay UE, where the fifth message is used to instruct the MME to send a sixth message to UE except the selected relay UE in the list of candidate relay UEs, and the sixth message is used to instruct the UE except the selected relay UE in the list of candidate relay UEs to stop sending a fourth message to the UE.

With reference to any one of the foregoing possible embodiments of the sixth aspect, in a fourth possible embodiment, the sending module is further configured to send a subscription request to the MME, where the subscription request is a request for the server to subscribe to a state, of losing a connection to a network, of the UE.

According to a seventh aspect, an embodiment of the present disclosure provides a system for connecting to a network, including:

a mobility management entity MME, configured to send a first message to a server, where the first message is used to notify the server that UE loses a connection to a network; and receive a second message sent by the server, where the second message is used to instruct the MME to perform a relay process, and the relay process specifically includes: acquiring a list of candidate relay UEs that relay the UE, and sending a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE;

the user equipment UE, configured to receive the fourth message sent by the UE in the list of candidate relay UEs, where the fourth message is used to instruct the UE to determine selected relay UE and connect to a network by using the selected relay UE; determine selected relay UE from candidate relay UEs corresponding to received fourth messages; and connect to a network by using the selected relay UE; and

the server, configured to receive the first message sent by the MME, where the first message is used to notify the server that the UE loses a connection to a network; and when it is determined that the UE needs to connect to a network by using the selected relay UE, send the second message to the MME, where the second message is used to instruct the MME to perform the relay process.

With reference to the seventh aspect, in a first possible embodiment, the system further includes: the selected relay UE, where:

the selected relay UE is configured to receive the third message sent by the MME, and send the fourth message to the UE according to content of the third message.

With reference to the seventh aspect or the first possible embodiment of the seventh aspect, in a second possible embodiment, the system further includes:

a gateway mobile location center GMLC, configured to receive an acquiring request sent by the server, where the acquiring request includes an identity ID of candidate relay UE that is located in a same cell as the UE and that relays the UE, and/or an ID of candidate relay UE that is located in a neighboring cell of a cell in which the UE is located and that relays the UE, where

the server is further configured to send the acquiring request to the GMLC, receive a request reply message sent by the GMLC, and generate the list of candidate relay UEs according to content of the request reply message, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE;

the server is further configured to receive an eighth message that carries an ID of the selected relay UE and is sent by the UE, where the eighth message is used to notify the server that the UE has connected to a network; and send, to the MME, a fifth message that carries the ID of the selected relay UE, where the fifth message is used to instruct the MME to send a sixth message to UE except the selected relay UE in the list of candidate relay UEs, and the sixth message is used to instruct the UE except the selected relay UE in the list of candidate relay UEs to stop sending the fourth message to the UE; and

the MME is further configured to receive the fifth message sent by the server, and send the sixth message to the UE except the selected relay UE in the list of candidate relay UEs according to content of the fifth message.

According to the method, the apparatus, and the system for connecting to a network that are provided in the embodiments of the present disclosure, an MME sends a first message to a server, where the first message is used to notify the server that UE loses a connection to a network; the MME receives a second message sent by the server, where the second message is used to instruct the MME to perform a relay process, and the relay process specifically includes: acquiring, by the MME, a list of candidate relay UEs that relay the UE, and sending a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE. In the prior art, when UE that is not located within a coverage area of a network needs to connect to the network, the UE actively selects and determines relay UE, and then connects to the relay UE, thereby implementing a connection to the network. However, when a network side needs to send data to the UE that is not located within the coverage area of the network and that is not connected to relay UE, there is no method for implementing interaction between the network side and the UE in the prior art, thereby preventing the UE from receiving data from the network side, and causing relatively poor user experience. In the embodiments, it may be implemented that a network side actively initiates a process of enabling UE that is not located within a coverage area of a network to connect to the network, thereby improving user experience.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a flowchart of a method for connecting to a network according to an embodiment of the present disclosure;

FIG. 2 is a flowchart of another method for connecting to a network according to an embodiment of the present disclosure;

FIG. 3 is a flowchart of still another method for connecting to a network according to an embodiment of the present disclosure;

FIG. 4 is a flowchart of a method for sending a first message to a server by an MME in a method for connecting to a network according to an embodiment of the present disclosure;

FIG. 5 is a flowchart of another method for sending a first message to a server by an MME in a method for connecting to a network according to an embodiment of the present disclosure;

FIG. 6 is a flowchart of a manner of acquiring a list of candidate relay UEs by an MME in a method for connecting to a network according to an embodiment of the present disclosure;

FIG. 7 is a flowchart of another manner of acquiring a list of candidate relay UEs by an MME in a method for connecting to a network according to an embodiment of the present disclosure;

FIG. 8A and FIG. 8B are a flowchart of yet another method for connecting to a network according to an embodiment of the present disclosure;

FIG. 9 is a schematic structural diagram of an apparatus for connecting to a network according to an embodiment of the present disclosure;

FIG. 10 is a schematic structural diagram of another apparatus for connecting to a network according to an embodiment of the present disclosure;

FIG. 11 is a schematic structural diagram of still another apparatus for connecting to a network according to an embodiment of the present disclosure;

FIG. 12 is a schematic structural diagram of yet another apparatus for connecting to a network according to an embodiment of the present disclosure;

FIG. 13 is a schematic structural diagram of still yet another apparatus for connecting to a network according to an embodiment of the present disclosure;

FIG. 14 is a structural diagram of hardware of an MME in a method for connecting to a network according to an embodiment of the present disclosure;

FIG. 15 is a structural diagram of hardware of UE in a method for connecting to a network according to an embodiment of the present disclosure;

FIG. 16 is a structural diagram of hardware of a server in a method for connecting to a network according to an embodiment of the present disclosure; and

FIG. 17 is a schematic structural diagram of a system for connecting to a network according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, for a method for connecting to a network provided in an embodiment of the present disclosure, the method is implemented on a premise that UE is directly connected to a core network. A connection to the network is lost (lost a connection to the network) for some reasons (for example, a signal becomes weak), so that the UE is located beyond a coverage area of the network.

When the core network needs to connect to the UE, as shown in FIG. 1, the following operations need to be performed:

101. An MME sends a first message to a server, where the first message is used to notify the server that UE loses a connection to a network.

The server is used for registration of a terminal, performs authentication and certification on a behavior of the terminal, and stores subscription data of the terminal and the like. In this embodiment, the server may be a proximity discovery and communication control functionality (PDCF) device, a proximity service server (Prose), a proximity service functionality (PSF) entity, or the like.

The first message includes an identity (ID) of the UE. The ID of the UE may be an international mobile subscriber identity (IMSI), or a service ID of the UE (such as a proximity services (Prose) ID). Optionally, the UE in this embodiment may be public safety (PS) UE.

Before sending the first message to the server, the MME needs to learn whether to report to the server that the UE loses a connection to a network. When the MME learns a manner of reporting to the server that the UE loses a connection to a network, the MME sends the first message to the server. When the MME learns the manner of reporting to the server that the user equipment UE loses a connection to a network, there are two conditions in which the MME needs to send the first message to the server.

In a first condition, the MME receives a seventh message that carries instruction information and that is sent by a base station, where the seventh message is used to notify the MME that the UE loses a connection to a network, and the instruction information is used to instruct the MME to report to the server that the UE loses a connection to a network. It should be noted that, the instruction information is information that the UE is a PS UE. An ID (service ID) of the PS UE is carried in the seventh message. Therefore, when receiving the seventh message, the MME learns, according to content of the seventh message, that the PS UE loses a connection to a network, and then sends the first message to the server according to the instruction information.

In a second condition, the MME receives a subscription request sent by the server, where the subscription request is a request for the server to subscribe to a state, of losing a connection to a network, of the UE. Therefore, when learning that the UE loses a connection to a network, the MME sends the first message to the server according to the subscription request. It may be understood that, in this condition, the UE may be PS UE or UE in a general situation.

102. The MME receives a second message sent by the server, where the second message is used to instruct the MME to perform a relay process.

Before the MME receives the second message sent by the server, the server determines whether the UE needs to connect to a network by using relay UE; when determining that the UE needs to connect to the network by using the relay UE, the server sends the second message to the MME, so that the MME starts to perform a relay process for the UE. Specifically, in this embodiment, the second message may be a relay initial request. Optionally, when the first message includes the IMSI of the UE, the second message may include the service ID (Prose ID) of the UE. The second message carries the Prose ID, so that the MME does not need to actively acquire the Prose ID, thereby improving efficiency of a network connection of the UE.

It should be noted that, the following steps 103 to 104 are steps of executing the relay process by the MME.

103. The MME acquires a list of candidate relay UEs that relay the UE.

After receiving the second message, the MME acquires the list of candidate relay UEs that relay the UE. An ID of relay UE that is suitable to be used as relay UE for the UE is included in the list of candidate relay UEs. Conditions of relay UE that is suitable for the UE include the following three points: first, the relay UE is relay UE; second, the relay UE is located in a same cell as the UE or located in a neighboring cell of a cell in which the UE is located; third, the relay UE has a same access point name (APN) as the UE. For example, both candidate relay UE in the list of candidate relay UEs and the UE are CMCC. When meeting the first condition and the second condition in the foregoing conditions, or the foregoing three conditions, relay UE may be used as candidate relay UE.

104. The MME sends a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE.

In this embodiment, the third message may be a relay active request, where the third message includes the service ID (Prose ID) of the UE.

According to the method for connecting to a network provided in this embodiment of the present disclosure, an MME sends a first message to a server, where the first message is used to notify the server that UE loses a connection to a network; the MME receives a second message sent by the server, where the second message is used to instruct the MME to perform a relay process, and the relay process specifically includes: acquiring, by the MME, a list of candidate relay UEs that relay the UE, and sending a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE. In the prior art, when UE that is not located within a coverage area of a network needs to connect to the network, the UE actively selects and determines relay UE, and then connects to the relay UE, thereby implementing a connection to the network. However, when a network side needs to send data to the UE that is not located within the coverage area of the network and that is not connected to relay UE, there is no method for implementing interaction between the network side and the UE in the prior art, thereby preventing the UE from receiving data from the network side, and causing relatively poor user experience. In this embodiment, it may be implemented that a network side actively initiates a process of enabling UE that is not located within a coverage area of a network to connect to the network, thereby improving user experience.

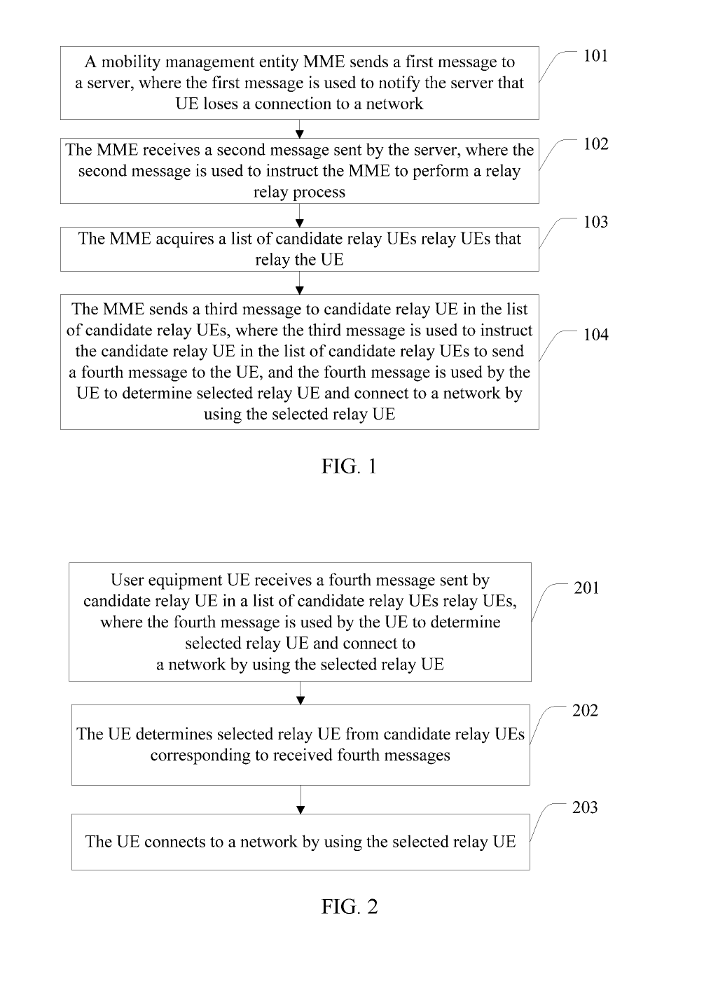

As shown in FIG. 2, an embodiment of the present disclosure provides another method for connecting to a network, where the method is as follows:

201. UE receives a fourth message sent by candidate relay UE in a list of candidate relay UEs, where the fourth message is used by the UE to determine selected relay UE and connect to a network by using the selected relay UE.

After receiving a third message sent by an MME, each candidate relay UE in the list of candidate relay UEs sends a fourth message to the UE in a broadcast manner. The fourth message sent by each candidate relay UE includes an ID (Prose ID) of an initiator (candidate relay UE).

Optionally, the fourth message further includes an ID of the UE.

202. The UE determines selected relay UE from candidate relay UEs corresponding to received fourth messages.

After receiving the fourth messages, the UE selects a suitable candidate relay UE as relay UE of the UE. The UE may use, for example, strong signal strength and close proximity to the UE, as a condition of the selected relay UE.

It should be noted that, when the fourth message includes the ID of the initiator (candidate relay UE), each UE (all UEs covered in a same area, which include the UE in this embodiment) that receives the fourth message separately sends a first request to relay UE that is suitable to be used as a relay of the UE; relay UE that receives the first request sent by each UE performs selection according to the ID of the UE in the third message, and selects the UE in this embodiment. In this way, a correspondence appears, that is, the UE is corresponding to the selected relay UE. The first request may be a relay connection request. The first request is used to request relay UE to forward relay data, where the relay data is data that the UE needs to send to another party through a network.

When the fourth message includes the ID of the initiator and the ID of the UE, the UE selects suitable relay UE as the selected relay UE after receiving the fourth messages.

203. The UE connects to a network by using the selected relay UE.

According to the method for connecting to a network provided in this embodiment of the present disclosure, UE receives a fourth message sent by candidate relay UE in a list of candidate relay UEs, where the fourth message is used by the UE to determine selected relay UE and connect to a network by using the selected relay UE; the UE determines selected relay UE from candidate relay UEs corresponding to received fourth messages, and connects to a network by using the selected relay UE. In the prior art, when UE that is not located within a coverage area of a network needs to connect to the network, the UE actively selects and determines relay UE, and then connects to the relay UE, thereby implementing a connection to the network. However, when a network side needs to send data to the UE that is not located within the coverage area of the network and that is not connected to relay UE, there is no method for implementing interaction between the network side and the UE in the prior art, thereby preventing the UE from receiving data from the network side, and causing relatively poor user experience. In this embodiment, it may be implemented that a network side actively initiates a process of enabling UE that is not located within a coverage area of a network to connect to the network, thereby improving user experience.

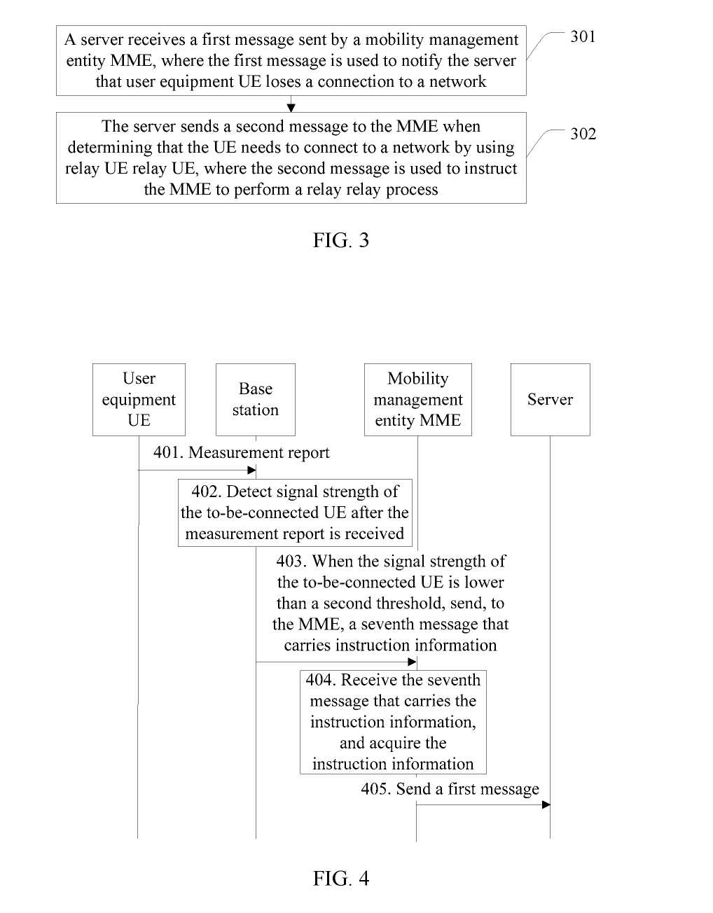

As shown in FIG. 3, an embodiment of the present disclosure provides still another method for connecting to a network, where the method is as follows:

301. A server receives a first message sent by an MME, where the first message is used to notify the server that UE loses a connection to a network.

The first message includes an ID (IMSI or Prose ID) of the UE.

After receiving the first message, the server determines whether the UE corresponding to the ID of the UE that is carried in the first message needs to connect to a network by using relay UE. Generally, in a case in which UE loses a connection to a network, whether the UE needs to connect to the network by using relay UE is preset by an operator.

It should be noted that, the server in this embodiment may be a PDCF device, a Prose device, a PSF entity, or the like.

302. The server sends a second message to the MME when determining that the UE needs to connect to a network by using relay UE, where the second message is used to instruct the MME to perform a relay process.

For a manner of performing the relay process by the MME, reference may be made to the descriptions in steps 103 to 104 in FIG. 1.

According to the method for connecting to a network provided in this embodiment of the present disclosure, a server receives a first message sent by an MME, where the first message is used to notify the server that UE loses a connection to a network; the server sends a second message to the MME when determining that the UE needs to connect to a network by using relay UE, where the second message is used to instruct the MME to perform a relay process. In the prior art, when UE that is not located within a coverage area of a network needs to connect to the network, the UE actively selects and determines relay UE, and then connects to the relay UE, thereby implementing a connection to the network. However, when a network side needs to send data to the UE that is not located within the coverage area of the network and that is not connected to relay UE, there is no method for implementing interaction between the network side and the UE in the prior art, thereby preventing the UE from receiving data from the network side, and causing relatively poor user experience. In this embodiment, it may be implemented that a network side actively initiates a process of enabling UE that is not located within a coverage area of a network to connect to the network, thereby improving user experience.

With reference to the method for connecting to a network in FIG. 1, an embodiment of the present disclosure provides a method for sending a first message to a server by an MME when the MME learns a manner of reporting to the server that UE loses a connection to a network in the method for connecting to a network. As shown in FIG. 4, the method is as follows:

401. UE sends a measurement report to a base station.

When the UE detects that its signal strength is lower than a first threshold, it indicates that the signal strength is relatively low. In this case, the UE is located beyond a coverage area of a network and needs to send a measurement report to the base station, where the measurement report is used to notify the base station that the signal strength of the UE is relatively low. The measurement report carries information that the UE is PS UE, information that the signal strength of the UE is relatively low, and an ID of the UE.

402. The base station detects signal strength of the UE after receiving the measurement report.

When detecting that the signal strength of the UE is lower than a second threshold, the base station continues to perform step 403;

when the base station detects that the signal strength of the UE is higher than or equal to the second threshold, this operation ends.

It may be understood that, in FIG. 4, the first threshold in step 401 may be the same as the second threshold, or may be different from the second threshold. This embodiment sets no limitation thereto.

403. When the signal strength of the UE is lower than a second threshold, the base station sends, to an MME, a seventh message that carries instruction information.

The instruction information is used to instruct the MME to report to a server that the UE loses a connection to a network.

In this embodiment, the seventh message may be a delete context request. Generally, in the prior art, when the base station detects that the signal strength of the UE is lower than the second threshold, the Delete Context request sent to the MME does not carry the instruction information, and therefore, in the prior art, when learning that the UE is located beyond a coverage area of a network, a network side cannot actively trigger the UE to connect to the network, that is, in the prior art, when receiving the Delete Context request, the MME does not send the first message described in step 101 in FIG. 1 to the server.

404. The MME receives the seventh message that carries the instruction information, and acquires the instruction information.

405. The MME sends a first message to a server.

By using instruction information in this embodiment of the present disclosure, it may be implemented that an MME sends a first message to a server when UE is in a state of losing a connection to a network, so that after receiving the first message, the server learns a situation that the UE loses a connection to a network.

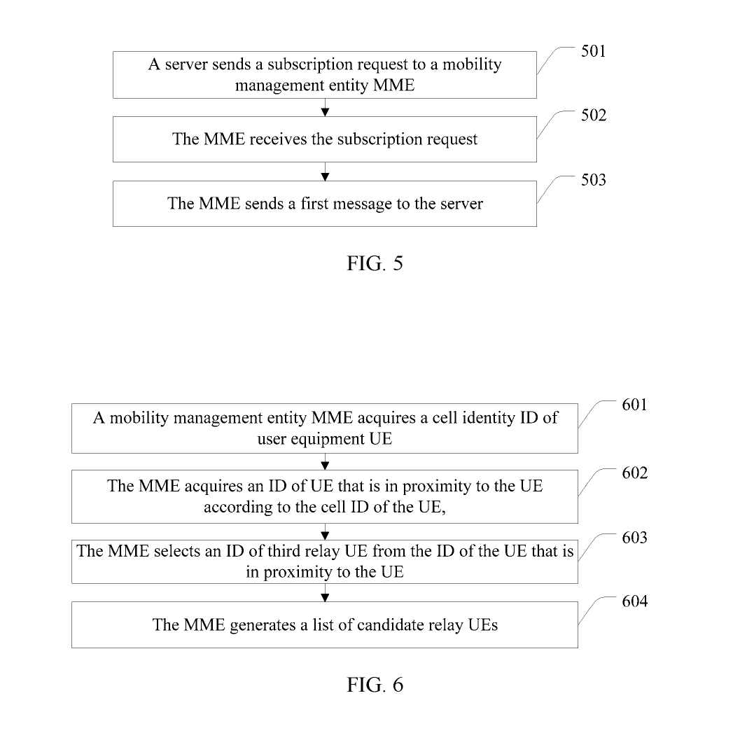

With reference to the method for connecting to a network in FIG. 1, an embodiment of the present disclosure provides another method for sending a first message to a server by an MME when the MME learns a manner of reporting to the server that user equipment UE loses a connection to a network in the method for connecting to a network. As shown in FIG. 5, the method is as follows:

501. A server sends a subscription request to an MME.

The subscription request is a request for the server to subscribe to a state, of losing a connection to a network, of UE, where

the subscription request includes an ID (IMSI or Prose ID) of the UE.

502. The MME receives the subscription request.

503. The MME sends a first message to the server.

After the MME receives the subscription request, a base station sends a Delete Context request to the MME when detecting that signal strength of the UE is relatively low. It should be noted that, the Delete Context request does not carry instruction information. After receiving the Delete Context request, the MME learns that the UE loses a connection to a network, and sends the first message to the server according to content of the subscription request (the server subscribes to the state, of losing a connection to a network, of the UE).

A subscription request is used in this embodiment, so that a measurement report sent by UE to a base station can be omitted. When detecting that signal strength of the UE is lower than a threshold, the base station sends, to an MME, a delete context request that carries an ID of the UE; after receiving the delete context request, the MME learns that the UE loses a connection to a network, and then sends a first message to a server according to the subscription request, so that after receiving the first message, the server learns a situation that the UE loses a connection to a network.

With reference to the method for connecting to a network shown in FIG. 1, that the MME acquires the list of candidate relay UEs is described in step 103, where there are two manners of acquiring the list of candidate relay UEs by the MME.

An embodiment of the present disclosure provides a manner of acquiring a list of candidate relay UEs by an MME in a method for connecting to a network. As shown in FIG. 6, the manner is as follows:

601. An MME acquires a cell ID of UE.

The cell ID of the UE may be an evolved universal mobile telecommunications system terrestrial radio access network cell global identifier (E-UTRAN Cell Global Identifier, ECGI), where E-UTRAN is an evolved universal mobile telecommunications system terrestrial radio access network.

Optionally, the MME acquires the cell ID of the UE from a second message sent by a server, that is, the second message described in FIG. 1 and FIG. 3 may further include the cell ID of the UE. Alternatively, optionally, the MME acquires the cell ID of the UE by itself.

602. The MME acquires an ID of UE that is in proximity to the UE according to the cell ID of the UE.

Specifically, the MME acquires an ID of candidate relay UE (ID of first relay UE) that is located in a same cell as the UE and that relays the UE, and/or an ID of candidate relay UE (ID of second relay UE) that is located in a neighboring cell of a cell in which the UE is located and that relays the UE. It may be understood that, the first relay UE is at least one UE, and the second relay UE is at least one UE.

603. The MME selects an ID of third relay UE from the ID of the UE that is in proximity to the UE.

Specifically, the MME selects the ID of the third relay UE from the ID of the first relay UE and/or the ID of the second relay UE, where the third relay UE has a same APN as the UE. It may be understood that, the third relay UE is at least one UE.

It should be noted that, this step is an optional step. The MME may directly perform step 604 after performing step 602.

604. The MME generates a list of candidate relay UEs.

The list of candidate relay UEs includes the ID of the candidate relay UE that is located in the same cell as the UE and that relays the UE, and/or the ID of the candidate relay UE that is located in the neighboring cell of the cell in which the UE is located and that relays the UE, that is, the list of candidate relay UEs includes the ID of the first relay UE and/or the ID of the second relay UE.

Optionally, when the MME generates the list of candidate relay UEs after performing step 603, the list of candidate relay UEs includes the ID of the third relay UE. By performing step 603 by the MME, a range of acquiring an ID of UE that is in proximity to the UE can be effectively narrowed, a quantity of third relay UEs included in the generated list of candidate relay UEs is relatively small, and the third relay UE has relatively high precision, so that less radio resources are occupied when candidate relay UE sends a fourth message to the UE.

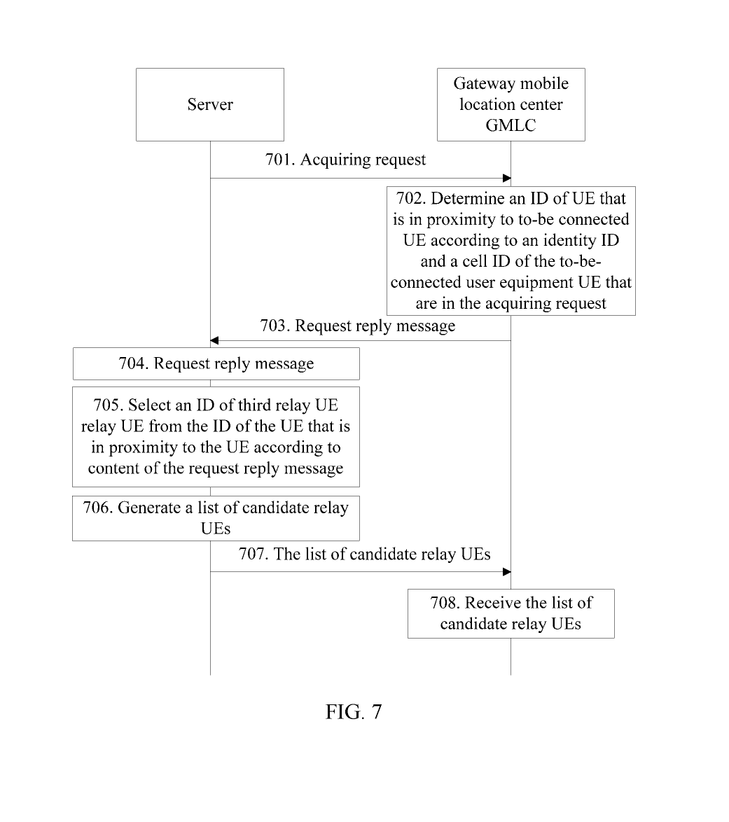

An embodiment of the present disclosure provides another manner of acquiring a list of candidate relay UEs by an MME in a method for connecting to a network. As shown in FIG. 7, the manner is as follows:

701. A server sends an acquiring request to a gateway mobile location center (GMLC), where

the acquiring request includes an ID (IMSI) and a cell ID of UE.

It should be noted that, when an MME acquires a list of candidate relay UEs in the manner shown in FIG. 7, the first message described in FIG. 1 and FIG. 3 further includes the cell ID of the UE.

The GMLC is used to acquire a location of a mobile terminal.

702. The GMLC determines an ID of UE that is in proximity to the UE according to the ID and the cell ID of the UE that are in the acquiring request.

It may be understood that, the ID of the UE that is in proximity to the UE may be an ID of candidate relay UE (ID of first relay UE) that is located in a same cell as the UE and that relays the UE, and/or an ID of candidate relay UE (ID of second relay UE) that is located in a neighboring cell of a cell in which the UE is located and that relays the UE.

703. The GMLC sends a request reply message to the server.

Specifically, the request reply message includes the ID of the UE that is in proximity to the UE (the ID of the first relay UE and/or the ID of the second relay UE).

704. The server receives the request reply message sent by the GMLC.

705. The server selects an ID of third relay UE from the ID of the UE that is in proximity to the UE according to content of the request reply message.

The third relay UE is UE that has a same access point name APN as the UE. Specifically, the server selects, according to the content of the request reply message, the ID of the third relay UE from the ID of the first relay UE and/or the ID of the second relay UE.

It should be noted that, this step is an optional step. The server may also directly perform step 706 after performing step 704 (after receiving the request reply message).

706. The server generates a list of candidate relay UEs.

The server directly generates the list of candidate relay UEs according to the content of the request reply message after receiving the request reply message, so that the list of candidate relay UEs includes the ID of the candidate relay UE (the ID of the first relay UE) that is located in the same cell as the UE and that relays the UE, and/or the ID of the candidate relay UE (the ID of the second relay UE) that is located in the neighboring cell of the cell in which the UE is located and that relays the UE.

The server continues to perform step 705 after receiving the request reply message, and then acquires the ID of the third relay UE, so that the list of candidate relay UEs includes the ID of the third relay UE.

707. The server sends the list of candidate relay UEs to an MME.

Specifically, the server may send the list of candidate relay UEs to the MME by using an independent message, or the server sends the second message described in FIG. 1 and FIG. 3 to the MME, where the second message is enabled to carry the list of candidate relay UEs. This embodiment sets no limitation on a manner of sending the list of candidate relay UEs by the server.

708. The MME receives the list of candidate relay UEs sent by the server.

In this embodiment, a GMLC determines an ID of UE that is in proximity to UE. Because the GMLC has relatively high locating precision, candidate relay UE in a finally determined list of candidate relay UEs is more close to the UE, that is, candidate relay UE is more precise, so that radio resources are saved when step 201 in FIG. 2 is being performed.

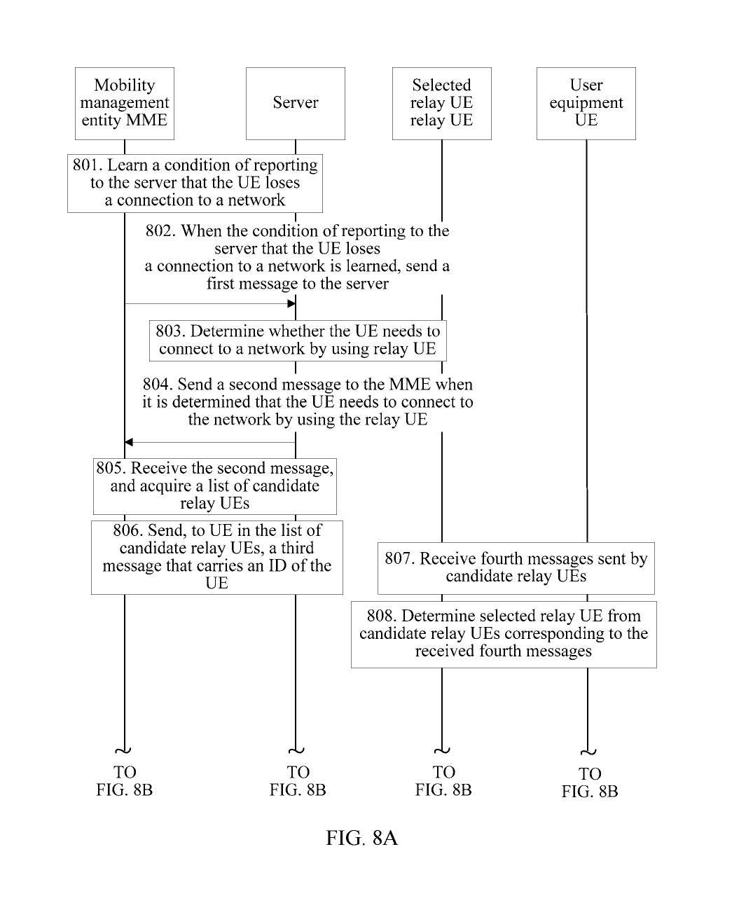

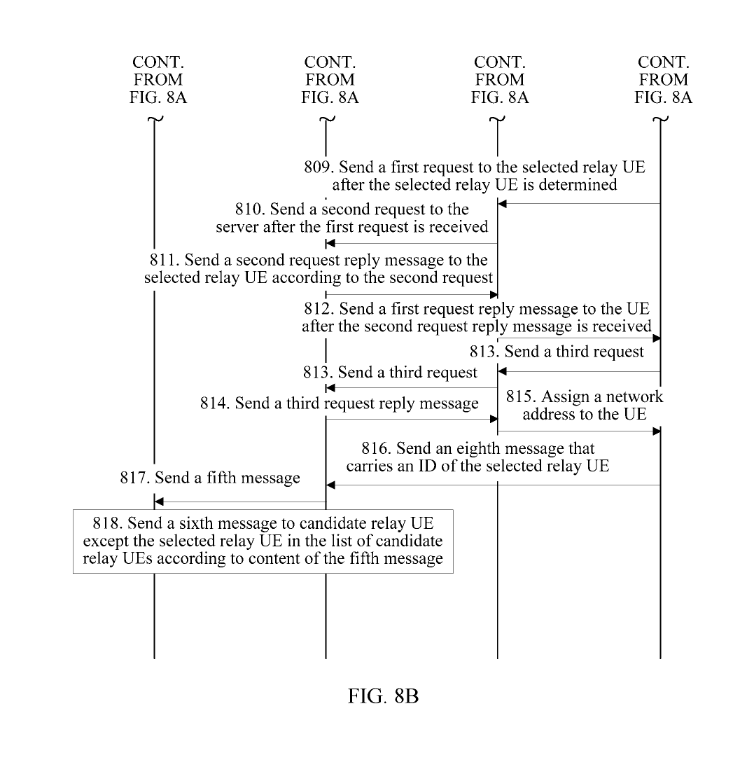

With reference to the methods for connecting to a network shown in FIG. 1 to FIG. 7, an embodiment of the present disclosure provides an implementation manner of connecting to a network. As shown in FIG. 8A and FIG. 8B, the implementation manner is as follows:

801. An MME learns a condition of reporting to a server that UE loses a connection to a network.

For a method for learning, by the MME, the condition of reporting to the server that the UE loses a connection to a network, reference may be made to a specific description in FIG. 4 or FIG. 5, and details are not described herein again.

802. The MME sends a first message to the server when learning the condition of reporting to the server that the UE loses a connection to a network.

The first message is used to notify the server that the UE loses a connection to a network.

803. The server determines whether the UE needs to connect to a network by using relay UE.

When the UE needs to connect to the network by using the relay UE, step 804 continues to be performed;

when the UE does not need to connect to the network by using the relay UE, this operation ends.

804. The server sends a second message to the MME when determining that the UE needs to connect to the network by using the relay UE.

The second message is used to instruct the MME to perform a relay process. Specifically, the following steps 805 to 806 are description of the relay process performed by the MME.

805. The MME receives the second message, and acquires a list of candidate relay UEs.

Optionally, the MME may generate the list of candidate relay UEs. Reference may be made to the specific steps described in FIG. 6.

Optionally, the MME may receive the list of candidate relay UEs sent by the server (acquire the list of candidate relay UEs from the second message; or acquire the list of candidate relay UEs from another independent message sent by the server). Reference may be made to the specific steps described in FIG. 7.

806. The MME sends, to UE in the list of candidate relay UEs, a third message that carries an ID of the UE.

The third message is used to instruct candidate relay UEs in the list of candidate relay UEs to send fourth messages to the UE.

807. The UE receives fourth messages sent by candidate relay UEs.

Specifically, the UE receives the fourth messages that are sent by the candidate relay UEs in the list of candidate relay UEs to the UE, where the fourth message is used by the UE to determine selected relay UE and connect to a network by using the selected relay UE.

808. The UE determines selected relay UE from the candidate relay UEs corresponding to the received fourth messages.

809. The UE sends a first request to the selected relay UE after determining the selected relay UE.

The first request includes a service ID (Prose ID) of the UE. The first request is used to request the selected relay UE to forward relay data, where the relay data is data that the UE needs to send to another party through a network.

810. The selected relay UE sends a second request to the server after receiving the first request.

The second request is used to request to acquire an authentication parameter of the UE, where the authentication parameter includes a random number.

811. The server sends a second request reply message to the selected relay UE according to the second request.

The second request reply message includes the authentication parameter of the UE.

It should be noted that, the server may serve at least one UE. Optionally, the UE is corresponding to a same server as the selected relay UE, or the UE and the selected relay UE are corresponding to different servers.

When the UE is corresponding to the same server as the selected relay UE, the server acquires the authentication parameter, and then sends, to the selected relay UE, the second request reply message that carries the authentication parameter.

When the UE and the selected relay UE are corresponding to different servers, for example, the UE is corresponding to a PDCF device, and the selected relay UE is corresponding to PDCF-relay UE, the server in this step is the PDCF-relay UE, that is, the PDCF-relay UE receives a relay connection request sent by the selected relay UE, and then sends, to the PDCF device, an authentication parameter acquiring request that carries the service ID (Prose ID) of the UE. The PDCF device receives the authentication parameter acquiring request, acquires the authentication parameter of the UE according to the service ID of the UE in the authentication parameter acquiring request, and then sends, to the PDCF-relay UE, an authentication parameter acquiring response that carries the authentication parameter. After acquiring the authentication parameter, the PDCF-relay UE sends, to the selected relay UE, the second request reply message that carries the authentication parameter.

812. The selected relay UE sends a first request reply message to the UE after receiving the second request reply message.

The first request reply message includes the authentication parameter.

The UE acquires the authentication parameter, and generates a corresponding authentication result. Specifically, the UE calculates the authentication parameter (random number) by using an encryption key, an encryption algorithm, or the like.

813. The UE sends a third request to the server by using the selected relay UE.

The third request is used to instruct the server to perform authentication on the authentication result. Specifically, the server detects whether the authentication result is correct, and when the authentication result is correct, it indicates that the UE is authorized UE, and then step 814 continues to be performed.

814. The server sends a third request reply message to the selected relay UE.

The third request reply message is a UE authentication success message.

815. The selected relay UE may assign a network address to the UE after receiving the third request reply message.

When the UE obtains the network address, it indicates that the UE successfully connects to a network. Afterwards, when the UE needs to send relay data, the selected relay UE directly forwards the relay data, but does not need to send the second request to the server.

816. The UE sends, to the server, an eighth message that carries an ID of the selected relay UE.

The eighth message is used to notify the server that the UE has connected to a network.

817. The server sends a fifth message to the MME.

The fifth message is used to instruct the MME to send a sixth message to candidate relay UE except the selected relay UE in the list of candidate relay UEs.

818. The MME sends, according to content of the fifth message, a sixth message to candidate relay UE except the selected relay UE in the list of candidate relay UEs.

The sixth message is used to instruct the candidate relay UE except the selected relay UE in the list of candidate relay UEs to stop sending the fourth message to the UE.

In this embodiment of the present disclosure, it is implemented that a network side actively initiates a process of enabling UE that is not located within a coverage area of a network to connect to the network, thereby improving user experience.

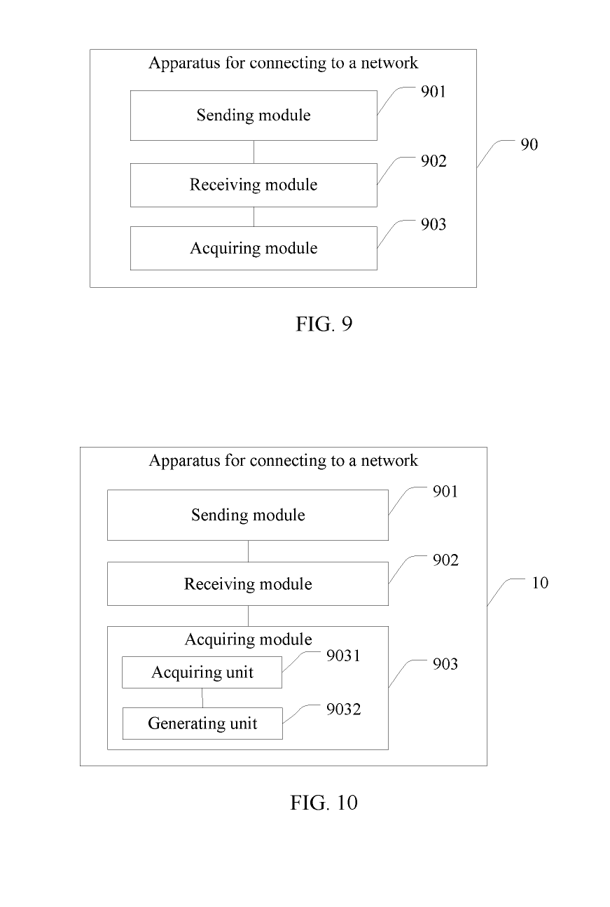

As shown in FIG. 9, an embodiment of the present disclosure provides an apparatus 90 for connecting to a network, including a sending module 901, a receiving module 902, and an acquiring module 903. The apparatus is the MME in the method embodiments.

The sending module 901 is configured to send a first message to a server, where the first message is used to notify the server that UE loses a connection to a network;

the receiving module 902 is configured to receive a second message sent by the server, where the second message is used to instruct the acquiring module 903 and the sending module 901 to perform a relay process; and

the acquiring module 903 is configured to acquire a list of candidate relay UEs that relay the UE, and provide the list of candidate relay UEs for the sending module 901, where

the sending module 901 is further configured to send a third message to candidate relay UE in the list of candidate relay UEs, where the third message is used to instruct the candidate relay UE in the list of candidate relay UEs to send a fourth message to the UE, and the fourth message is used by the UE to determine selected relay UE and connect to a network by using the selected relay UE.

It should be noted that, before the sending module 901 sends the first message to the server, the receiving module 902 is further configured to learn a condition of reporting to the server that the user equipment UE loses a connection to a network. Specifically, there are two manners of learning, by the receiving module 902, the condition of reporting to the server that the user equipment UE loses a connection to a network.

A first manner: The receiving module 902 receives a seventh message that carries instruction information and that is sent by a base station, where the seventh message is used to notify the apparatus 90 that the UE loses a connection to a network, and the instruction information is used to instruct the sending module 901 to report to the server that the UE loses a connection to a network.

A second manner: The receiving module 902 receives a subscription request sent by the server, where the subscription request is a request for the server to subscribe to a state, of losing a connection to a network, of the UE.

Further, the present disclosure further provides another apparatus 10 for connecting to a network, where the acquiring module 903 of the apparatus 10 for connecting to a network includes an acquiring unit 9031 and a generating unit 9032.

That the acquiring module 903 acquires the list of candidate relay UEs is specifically as follows:

Optionally, the acquiring module 903 acquires the list of candidate relay UEs from the second message received by the receiving module 902, where the second message includes the list of candidate relay UEs. A precondition is that the first message further includes a cell ID of the UE, that is, the first message sent by the sending module 901 to the server further includes the cell ID of the UE. Then, the server sends, to a GMLC, an acquiring request that carries the cell ID of the UE, so that the GMLC determines an ID of UE that is in proximity to the UE.

Optionally, the acquiring unit 9031 acquires an ID of candidate relay UE that is located in a same cell as the UE and that relays the UE, and/or an ID of candidate relay UE that is located in a neighboring cell of a cell in which the UE is located and that relays the UE; and provides an acquiring result for the generating unit 9032. The generating unit 9032 generates the list of candidate relay UEs according to the acquiring result provided by the acquiring unit 9031, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE.

Further, after the sending module 903 sends, to UE in the list of candidate relay UEs, the third message that carries an ID of the UE, the receiving module 902 is further configured to receive a fifth message that carries an ID of the selected relay UE and that is sent by the server, where the fifth message is used to instruct the sending module 901 to send a sixth message to candidate relay UE except the selected relay UE in the list of candidate relay UEs, and the sixth message is used to instruct the candidate relay UE except the selected relay UE in the list of candidate relay UEs to stop sending the fourth message to the UE; then, the sending module 901 sends the sixth message to the candidate relay UE except the selected relay UE in the list of candidate relay UEs.

It should be noted that, because content such as specific implementation processes of modules and information exchange between the modules in the apparatus 90 shown in FIG. 9 and the apparatus 10 shown in FIG. 10 is based on a same disclosure concept as the method embodiments of the present disclosure, reference may be made to the method embodiments, and details are not described herein again.

When learning a manner of reporting to a server that user equipment UE loses a connection to a network, a sending module sends a first message to the server, where the first message is used to notify the server that the UE loses a connection to a network; a receiving module receives a second message sent by the server, where the second message is used to instruct an acquiring module and the sending module to perform a relay process; the acquiring module acquires a list of candidate relay UEs that relay the UE; then, the sending module sends a third message to candidate relay UE in the list of candidate relay UEs, where the third message is used to instruct the candidate relay UE in the list of candidate relay UEs to send a fourth message to the UE, where the fourth message is used to instruct the UE to determine selected relay UE and connect to a network by using the selected relay UE. In the present disclosure, it is implemented that a network side actively initiates a process of enabling UE that is not located within a coverage area of a network to connect to the network, thereby improving user experience.

As shown in FIG. 11, an embodiment of the present disclosure provides another apparatus 11 for connecting to a network, including: a receiving module 1101, a determining module 1102, and a connecting module 1103. The apparatus is the UE in the method embodiments.

The receiving module 1101 is configured to receive a fourth message sent by candidate relay UE in a list of candidate relay UEs, and provide the fourth message for the determining module 1102, where the fourth message is used to instruct the determining module 1102 to determine selected relay UE and the connecting module 1103 to connect to a network by using the selected relay UE;

the determining module 1102 is configured to determine selected relay UE from candidate relay UEs corresponding to received fourth messages, and provide an ID of the selected relay UE for the connecting module 1103; and

the connecting module 1103 is configured to connect to a network by using the selected relay UE.

Further, when the connecting module 1103 has connected to relay UE, the connecting module 1103 sends, to a server, an eighth message that carries an ID of the relay UE, where the eighth message is used to notify the server that the connecting module 1103 has connected to a network.

Further and optionally, the fourth message carries an identity ID of the apparatus 11; the determining module 1102 is further configured to determine the selected relay UE according to the ID of the apparatus 11 that is carried in the received fourth messages.

It should be noted that, because content such as specific implementation processes of modules and information exchange between the modules in the apparatus 11 shown in FIG. 11 is based on a same disclosure concept as the method embodiments of the present disclosure, reference may be made to the method embodiments, and details are not described herein again.

A receiving module receives a fourth message sent by candidate relay UE in a list of candidate relay UEs, and provides the fourth message for a determining module, where the fourth message is used to instruct the determining module to determine selected relay UE and a connecting module to connect to a network by using the selected relay UE; the determining module determines selected relay UE from candidate relay UEs corresponding to received fourth messages, and provides an ID of the selected relay UE for the connecting module; the connecting module connects to a network by using the selected relay UE. In the present disclosure, it is implemented that a network side actively initiates a process of enabling UE that is not located within a coverage area of a network to connect to the network, thereby improving user experience.

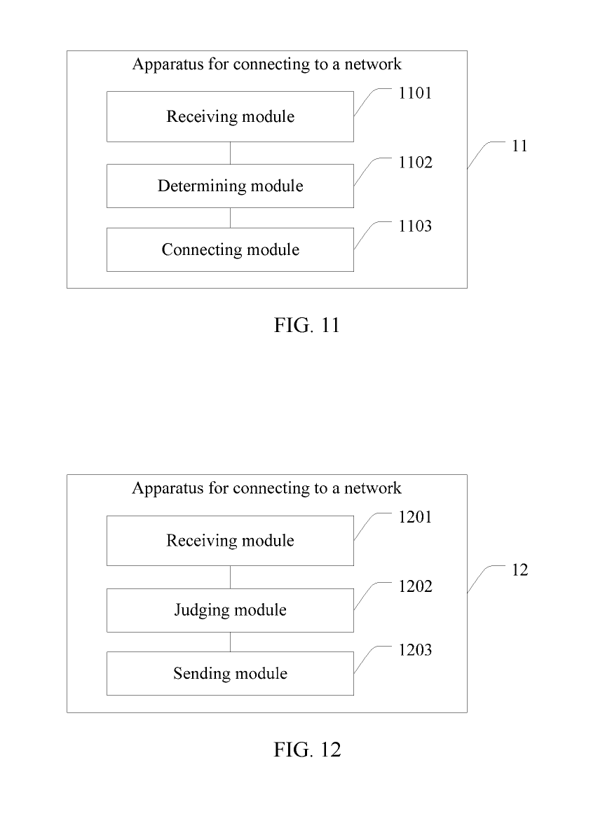

As shown in FIG. 12, an embodiment of the present disclosure provides another apparatus 12 for connecting to a network, including: a receiving module 1201, a judging module 1202, and a sending module 1203. The apparatus is the server in the method embodiments.

The receiving module 1201 is configured to receive a first message sent by an MME, and provide the first message for the judging module 1202, where the first message is used to notify the server that UE loses a connection to a network;

the judging module 1202 is configured to determine whether the UE needs to connect to a network by using relay UE, and provide a result of the determining for the sending module 1203; and

the sending module 1203 is configured to send a second message to the MME when the result of the determining is that the UE needs to connect to the network by using the relay UE, where the second message is used to instruct the MME to perform a relay process.

Further, the present disclosure further provides another apparatus 13 for connecting to a network, where the apparatus 13 for connecting to a network further includes a processing module 1204, and the processing module 1204 includes a sending unit 12041, a receiving unit 12042, and a generating unit 12043.

Optionally, the processing module 1204 is configured to generate a list of candidate relay UEs.

Specifically, the sending unit 12041 in the processing module 1204 sends an acquiring request to a GMLC, where the acquiring request includes an ID and a cell ID of the UE; the receiving unit 12042 receives a request reply message sent by the GMLC, and provides the request reply message for the generating unit 12043, where the request reply message includes an ID of first relay UE that is located in a same cell as the UE, and/or an ID of second relay UE that is located in a neighboring cell of a cell in which the UE is located; then, the generating unit 12043 generates the list of candidate relay UEs according to the request reply message provided by the receiving unit 12042, where the list of candidate relay UEs includes the ID of the first relay UE that is located in the same cell as the UE and that relays the UE, and/or an ID of the second relay UE that is located in the neighboring cell of a cell in which the UE is located and that relays the UE.

Further, when the result of the determining is that the UE needs to connect to the network by using the relay UE, the sending module 1203 sends, to the MME, the second message that carries the list of candidate relay UEs. Certainly, the sending module 1203 may send, to the MME, an independent message that carries the list of candidate relay UEs, but does not need to attach the list of candidate relay UEs to the second message.

Further, before the receiving module 1201 receives the first message sent by the MME, the sending module 1203 is further configured to send a subscription request to the MME, where the subscription request is a request for the server to subscribe to a state, of losing a connection to a network, of the UE.

Further, after the UE connects to a network, the receiving module 1201 is further configured to receive an eighth message that carries an ID of a selected relay UE and that is sent by the UE, where the eighth message is used to notify the apparatus 13 that the UE has connected to a network; then, the sending module 1203 sends, to the MME, a fifth message that carries the ID of the selected relay UE, where the fifth message is used to instruct the MME to send a sixth message to UE except the selected relay UE in the list of candidate relay UEs, and the sixth message is used to instruct the UE except the selected relay UE in the list of candidate relay UEs to stop sending a fourth message to the UE.

It should be noted that, because content such as specific implementation processes of modules and information exchange between the modules in the apparatus 12 shown in FIG. 12 and the apparatus 13 shown in FIG. 13 is based on a same disclosure concept as the method embodiments of the present disclosure, reference may be made to the method embodiments, and details are not described herein again.

A receiving module receives a fourth message sent by candidate relay UE in a list of candidate relay UEs, and provides the fourth message for a determining module, where the fourth message is used to instruct the determining module to determine selected relay UE and a connecting module to connect to a network by using the selected relay UE; the determining module determines selected relay UE from candidate relay UEs corresponding to received fourth messages, and provides an ID of the selected relay UE for the connecting module; and the connecting module connects to a network by using the selected relay UE. In the present disclosure, it is implemented that a network side actively initiates a process of enabling UE that is not located within a coverage area of a network to connect to the network, thereby improving user experience.

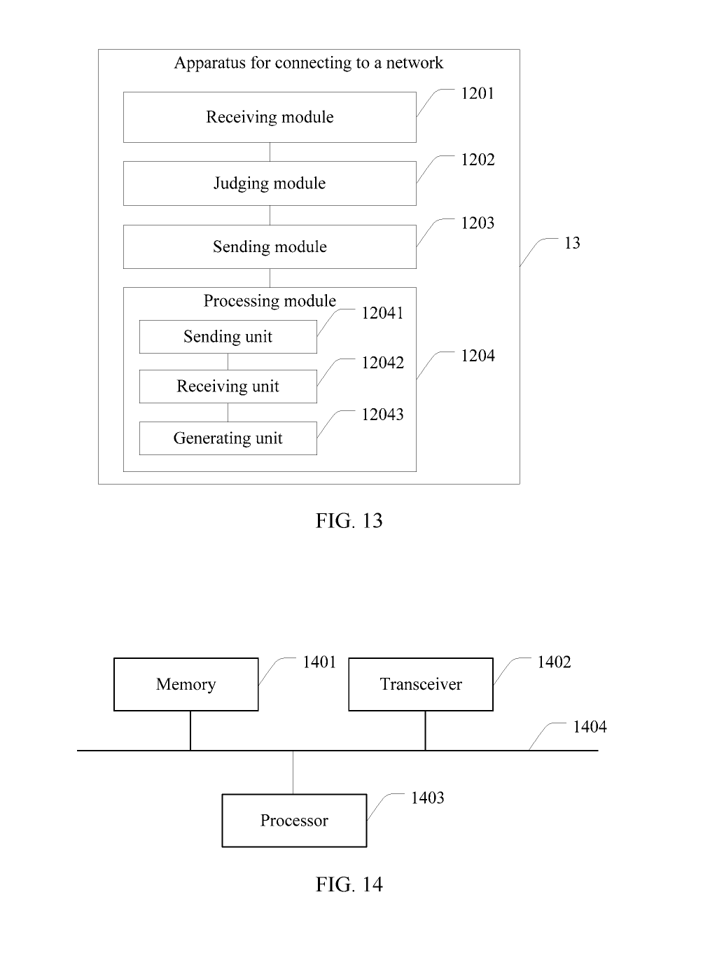

As shown in FIG. 14, FIG. 14 is a schematic structural diagram of hardware of an MME. The MME may include a memory 1401, a transceiver 1402, a processor 1403, and a bus 1404, where the memory 1401, the transceiver 1402, and the processor 1403 connect to and communicate with each other by using the bus 1404.

The memory 1401 may be a read-only memory (ROM), a static storage device, a dynamic storage device, or a random access memory (RAM). The memory 1401 may store an operating system and another application program. When the technical solutions provided by embodiments of the present disclosure are being implemented by using software or firmware, program code that is used to implement the technical solutions provided by the embodiments of the present disclosure is stored in the memory 1401 and executed by the processor 1403.

The transceiver 1402 is configured to perform communication between the apparatus and another device or a communications network (for example, that includes but is not limited to Ethernet, a radio access network (RAN), and a wireless local area network (WLAN)).

The processor 1403 may be a general central processing unit (CPU), a microprocessor, an application-specific integrated circuit (ASIC), or one or more integrated circuits, and is configured to execute a related program, so as to implement the technical solutions provided in the embodiments of the present disclosure.

The bus 1404 may include a channel that transmits information between each part (for example, the memory 1401, the transceiver 1402, and the processor 1403) of the apparatus.

It should be noted that, although only hardware the memory 1401, the transceiver 1402, the processor 1403, and the bus 1404 are shown in FIG. 14, in a specific implementation process, persons skilled in the art should understand that, the terminal further includes another component that is necessary for normal operating. In addition, according to a specific need, persons skilled in the art should understand that, the terminal may further include a hardware component that implements another function.

Specifically, when the MME shown in FIG. 14 is configured to implement the apparatus shown in the embodiments of FIG. 9 to FIG. 10, the transceiver 1402 in the apparatus is configured to send a first message to a server, where the first message is used to notify the server that UE loses a connection to a network; and receive a second message sent by the server, where the second message is used to instruct the processor 1403 and the transceiver 1402 to perform a relay process.

It should be noted that, before sending the first message to the server, the transceiver 1402 further needs to learn a condition of reporting to the server that the user equipment UE loses a connection to a network. There are two manners of learning, by the transceiver 1402, the condition of reporting to the server that the user equipment UE loses a connection to a network. The manners specifically include the following:

A first manner: The transceiver 1402 receives a seventh message that carries instruction information and that is sent by a base station, where the seventh message is used to notify the apparatus that the UE loses a connection to a network, and the instruction information is used to instruct the transceiver 1402 to report to the server that the UE loses a connection to a network.

A second manner: The transceiver 1402 receives a subscription request sent by the server, where the subscription request is a request for the server to subscribe to a state, of losing a connection to a network, of the UE.

The processor 1403 is configured to acquire a list of candidate relay UEs, and provide the list of candidate relay UEs for the transceiver 1402.

Specifically, an implementation manner of acquiring the list of candidate relay UEs by the processor 1403 is as follows:

Optionally, the processor 1403 acquires an ID of candidate relay UE that is located in a same cell as the UE and that relays the UE, and/or an ID of candidate relay UE that is located in a neighboring cell of a cell in which the UE is located and that relays the UE; and generates the list of candidate relay UEs, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE.

Optionally, the processor 1403 acquires the list of candidate relay UEs from the second message received by the transceiver 1402, where the second message includes the list of candidate relay UEs. A precondition is that the first message further includes a cell ID of the UE, that is, the first message that is sent by the transceiver 1402 to the server further includes the cell ID of the UE. Then, the transceiver 1402 sends, to a GMLC, an acquiring request that carries the cell ID of the UE, so that the GMLC determines an ID of UE that is in proximity to the UE.

The transceiver 1402 is further configured to send a third message to candidate relay UE in the list of candidate relay UEs, where the third message is used to instruct the candidate relay UE in the list of candidate relay UEs to send a fourth message to the UE, and the fourth message is used to instruct the UE to determine selected relay UE and connect to a network by using the selected relay UE.

Further, the transceiver 1402 is further configured to receive a fifth message that carries an ID of the selected relay UE and that is sent by the server, where the fifth message is used to instruct the transceiver 1402 to send a sixth message to candidate relay UE except the selected relay UE in the list of candidate relay UEs, and the sixth message is used to instruct the candidate relay UE except the selected relay UE in the list of candidate relay UEs to stop sending the fourth message to the transceiver 1402, and then, the transceiver 1402 sends the sixth message to the candidate relay UE except the selected relay UE in the list of candidate relay UEs according to the fifth message.

In the present disclosure, it is implemented that a network side actively initiates a process of enabling UE that is not located within a coverage area of a network to connect to the network, thereby improving user experience.

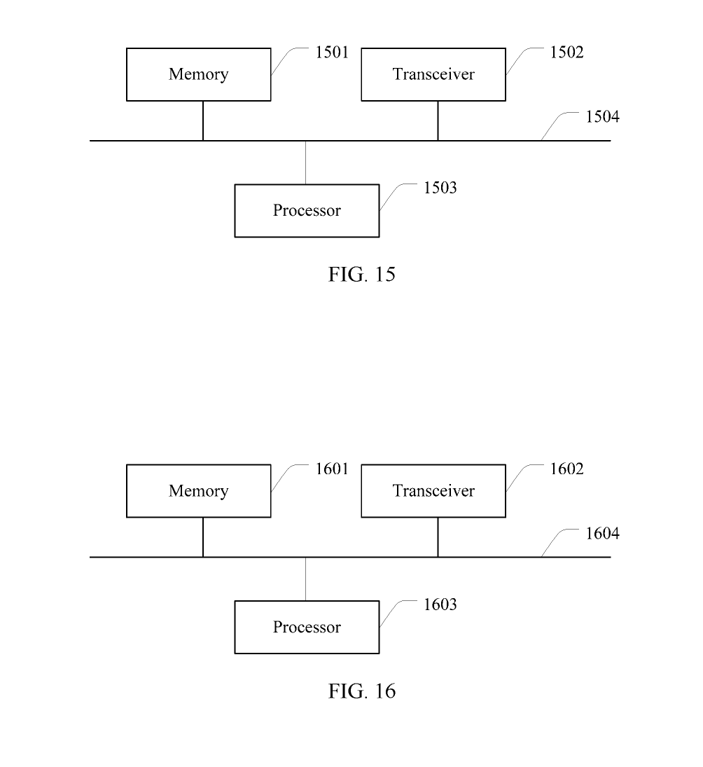

As shown in FIG. 15, FIG. 15 is a schematic structural diagram of hardware of UE. The UE may include a memory 1501, a transceiver 1502, a processor 1503, and a bus 1504, where the memory 1501, the transceiver 1502, and the processor 1503 connect to and communicate with each other by using the bus 1504.

For description of common functions of the memory 1501, the transceiver 1502, the processor 1503, and the bus 1504 in the apparatus, reference may be made to the description of the memory 1401, the transceiver 1402, the processor 1403, and the bus 1404 that are included in the MME in FIG. 14. Details are not described herein again.

It should be noted that, although only hardware the memory 1501, the transceiver 1502, the processor 1503, and the bus 1504 are shown in FIG. 15, in a specific implementation process, persons skilled in the art should understand that, the terminal further includes another component that is necessary for normal operating. In addition, according to a specific need, persons skilled in the art should understand that, the terminal may further include a hardware component that implements another function.

Specifically, when the UE shown in FIG. 15 is configured to implement the apparatus shown in the embodiment of FIG. 11, the transceiver 1502 in this apparatus is configured to receive a fourth message sent by candidate relay UE in a list of candidate relay UEs, and provide the fourth message for the processor 1503, where the fourth message is used to instruct the processor 1503 to determine selected relay UE and connect to a network by using the selected relay UE.

The processor 1503 is configured to determine selected relay UE from candidate relay UEs corresponding to received fourth messages; and connect to a network by using the selected relay UE.

Further, when the processor 1503 has connected to the selected relay UE, the transceiver 1502 is further configured to send, to the server, an eighth message that carries an ID of the selected relay UE, where the eighth message is used to notify the server that the processor 1503 has connected to a network.

Further and optionally, the fourth message carries an identity ID of the apparatus; the processor 1503 determines the selected relay UE according to the ID of the apparatus that is carried in the received fourth messages.

In this embodiment of the present disclosure, it is implemented that a network side actively initiates a process of enabling UE that is not located within a coverage area of a network to connect to the network, thereby improving user experience.

As shown in FIG. 16, FIG. 16 is a schematic structural diagram of hardware of a server. The server may include a memory 1601, a transceiver 1602, a processor 1603, and a bus 1604, where the memory 1601, the transceiver 1602, and the processor 1603 connect to and communicate with each other by using the bus 1604.

For description of common functions of the memory 1601, the transceiver 1602, the processor 1603, and the bus 1604 in the apparatus, reference may be made to the description of the memory 1401, the transceiver 1402, the processor 1403, and the bus 1404 that are included in the MME in FIG. 14. Details are not described herein again.

It should be noted that, although only hardware the memory 1601, the transceiver 1602, the processor 1603, and the bus 1604 are shown in FIG. 16, in a specific implementation process, persons skilled in the art should understand that, the terminal further includes another component that is necessary for normal operating. In addition, according to a specific need, persons skilled in the art should understand that, the terminal may further include a hardware component that implements another function.

Specifically, when the server shown in FIG. 16 is configured to implement the apparatus shown in the embodiments of FIG. 12 and FIG. 13, the transceiver 1602 in this apparatus is configured to receive a first message sent by an MME, and provide the first message for the processor 1603, where the first message is used to notify the server that UE loses a connection to a network.

It should be noted that, before receiving the first message, the transceiver 1602 is further configured to send a subscription request to the MME, where the subscription request is a request for the server to subscribe to a state, of losing a connection to a network, of the UE.

The processor 1603 is configured to determine whether the UE needs to connect to a network by using relay UE, and provide a result of the determining for the transceiver 1602; and

the transceiver 1602 is configured to send a second message to the MME when the result of the determining is that the UE needs to connect to the network by using the relay UE, where the second message is used to instruct the MME to perform a relay process.

Further and optionally, the processor 1603 is further configured to generate a list of candidate relay UEs, and then, the transceiver 1602 is further configured to, when the result of the determining is that the UE needs to connect to the network by using the relay UE, send, to the MME, the second message that carries the list of candidate relay UEs. Certainly, the transceiver 1602 may send, to the MME, an independent message that carries the list of candidate relay UEs, but does not need to attach the list of candidate relay UEs to the second message.

An implementation manner of generating the list of candidate relay UEs by the processor 1603 specifically includes the following:

The processor 1603 sends an acquiring request to a GMLC, where the acquiring request includes an ID and a cell ID of the UE; the transceiver 1602 receives a request reply message sent by the GMLC, and provides the request reply message for the processor 1603, where the request reply message includes an ID of candidate relay UE that is located in a same cell as the UE and that relays the UE, and/or an ID of candidate relay UE that is located in a neighboring cell of a cell in which the UE is located and that relays the UE; and then, the processor 1603 generates the list of candidate relay UEs according to content of the request reply message, where the list of candidate relay UEs includes the ID of the candidate relay UE that is located in the same cell as the UE and that relays the UE, and/or the ID of the candidate relay UE that is located in the neighboring cell of the cell in which the UE is located and that relays the UE.

Further, after the processor 1603 connects to a network, the transceiver 1602 is further configured to receive an eighth message that carries an ID of selected relay UE and that is sent by the UE, where the eighth message is used to notify the server that the UE has connected to a network.

Further, the transceiver 1602 is further configured to send, to the MME, a fifth message that carries the ID of the selected relay UE, where the fifth message is used to instruct the MME to send a sixth message to UE except the selected relay UE in the list of candidate relay UEs, and the sixth message is used to instruct the UE except the selected relay UE in the list of candidate relay UEs to stop sending a fourth message to the UE.

In the present disclosure, it is implemented that a network side actively initiates a process of enabling UE that is not located within a coverage area of a network to connect to the network, thereby improving user experience.

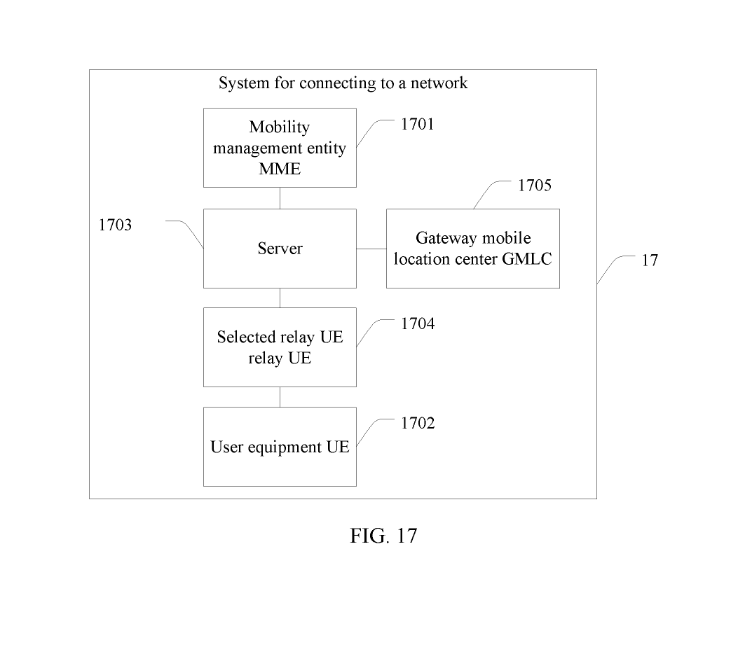

As shown in FIG. 17, an embodiment of the present disclosure provides a system 17 for connecting to a network, including an MME 1701, UE 1702, a server 1703, selected relay UE 1704, and a GMLC 1705, where

the MME 1701 is configured to send a first message to the server 1703, where the first message is used to notify the server 1703 that the UE 1702 loses a connection to a network; receive a second message sent by the server 1703, where the second message is used to instruct the MME 1701 to perform a relay process, where the relay process specifically includes: acquiring a list of candidate relay UEs that relay the UE 1702, and sending a third message to candidate relay UE in the list of candidate relay UEs, where the third message is used to instruct the candidate relay UE in the list of candidate relay UEs to send a fourth message to the UE 1702, and the fourth message is used to instruct the UE 1702 to determine the selected relay UE 1704 and connect to a network by using the selected relay UE 1704;

the UE 1702 is configured to receive the fourth message sent by the UE in the list of candidate relay UEs, where the fourth message is used to instruct the UE 1702 to determine selected relay UE 1704 and connect to a network by using the selected relay UE 1704; determine the selected relay UE 1704 from candidate relay UEs corresponding to received fourth messages; and connect to a network by using the selected relay UE 1704;

the server 1703 is configured to receive the first message sent by the MME 1701, where the first message is used to notify the server 1703 that the UE 1702 loses a connection to a network; and send the second message to the MME 1701 when determining that the UE 1702 needs to connect to a network by using relay UE, where the second message is used to instruct the MME 1701 to perform the relay process; and

the selected relay UE 1704 is configured to receive the third message sent by the MME 1701; and send the fourth message to the UE 1702 according to content of the third message.

Optionally, the system 17 for connecting to a network may further include the GMLC 1705 that is configured to receive an acquiring request sent by the server 1703, where the acquiring request includes an ID and a cell ID of the UE 1702, and send a request reply message to the server 1703, where the request reply message includes an ID of candidate relay UE that is located in a same cell as the UE 1702 and that relays the UE 1702, and/or an ID of candidate relay UE that is located in a neighboring cell of a cell in which the UE 1702 is located and that relays the UE 1702.

The server 1703 is further configured to send the acquiring request to the GMLC 1705; receive the request reply message sent by the GMLC 1705; select an ID of third relay UE from an ID of first relay UE and/or an ID of second relay UE according to content of the request reply message; and generate the list of candidate relay UEs, where the list of candidate relay UEs includes the ID of the candidate relay UE that is located in the same cell as the UE 1702 and that relays the UE 1702, and/or the ID of the candidate relay UE that is located in the neighboring cell of the cell in which the UE 1702 is located and that relays the UE 1702.

It should be noted that, the system 17 may also not include the GMLC 1705, that is, when generating the list of candidate relay UEs, the MME 1701 may not need to receive the list of candidate relay UEs sent by the server 1703. Therefore, although the system 17 does not include the GMLC 1705, connecting to a network by the UE 1702 can be implemented. To make a comprehensive description, that the system 17 for connecting to a network includes the GMLC 1705 is used as an example for description.

The server 1703 is further configured to receive an eighth message that carries an ID of the selected relay UE and that is sent by the UE 1702, where the eighth message is used to notify the server 1703 that the UE 1702 has connected to a network; and send, to the MME 1701, a fifth message that carries the ID of the selected relay UE, where the fifth message is used to instruct the MME 1701 to send a sixth message to UE except the selected relay UE in the list of candidate relay UEs, and the sixth message is used to instruct the UE except the selected relay UE in the list of candidate relay UEs to stop sending the fourth message to the UE 1702.

The MME 1701 is further configured to receive the fifth message sent by the server 1703; and send the sixth message to the UE except the selected relay UE in the list of candidate relay UEs according to content of the fifth message.

In the present disclosure, it is implemented that a network side actively initiates a process of enabling UE that is not located within a coverage area of a network to connect to the network, thereby improving user experience.

It may be clearly understood by persons skilled in the art that, for the purpose of convenient and brief description, only the division of the foregoing functional modules is described by using an example, and in an actual application, the foregoing functions may be accomplished by different functional modules according to a requirement, that is, the inner structure of the apparatus is divided into different functional modules to accomplish all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely a logical function division and may be other divisions in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or a part of the technical solutions may be implemented in the form of a software product. The computer software product is stored in a storage medium and includes several instructions for instructing a computer device (which may be a personal computer, a server, a network device, or the like) or a processor (processor) to perform all or a part of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementation manners of the present disclosure, but are not intended to limit the protection scope of the present disclosure. Any variation or replacement readily figured out by persons skilled in the art within the technical scope disclosed in the present disclosure shall fall within the protection scope of the present disclosure. Therefore, the protection scope of the present disclosure shall be subject to the protection scope of the claims.

What is claimed is:

1. A method for connecting to a network, the method comprising:
sending, by a mobility management entity (MME), a first message to a server, wherein the first message notifies the server that a user equipment (UE) loses a connection to the network; and
receiving, by the MME, a second message sent by the server, wherein the second message instructs the MME to perform a relay process, wherein the relay process comprises:
acquiring, by the MME, a list of candidate relay UEs that relay the UE, and
sending, by the MME, a third message to candidate relay UE in the list of candidate relay UEs, wherein the third message instructs the candidate relay UE in the list of candidate relay UEs to send a fourth message to the UE, and the fourth message is used by the UE to determine a selected relay UE and connect to the network using the selected relay UE.

2. The method according to claim 1, wherein the acquiring, by the MME, the list of candidate relay UEs comprises:
acquiring, by the MME, an identity (ID) of one or more of: a candidate relay UE that is located in a same cell as the UE and that relays the UE, and a candidate relay UE that is located in a neighboring cell of a cell in which the UE is located and that relays the UE; and
generating, by the MME, the list of candidate relay UEs, wherein the list of candidate relay UEs comprises the ID of one or more of: the candidate relay UE that is located in the same cell as the UE and that relays the UE, and the candidate relay UE that is located in the neighboring cell of the cell in which the UE is located and that relays the UE.

3. The method according to claim 1, wherein the first message comprises a cell ID of the UE, and the second message comprises the list of candidate relay UEs that relay the UE; and
the acquiring, by the MME, the list of candidate relay UEs comprises:
acquiring, by the MME, the list of candidate relay UEs from the second message.

4. The method according to claim 1, wherein after the sending, by the MME, the third message to the candidate relay UE, the method further comprises:
receiving, by the MME, a fifth message that carries an ID of the selected relay UE and that is sent by the server, wherein the fifth message instructs the MME to send a sixth message to a candidate relay UE other than the selected relay UE in the list of candidate relay UEs, and the sixth message instructs the candidate relay UE other than the selected relay UE in the list of candidate relay UEs to stop sending the fourth message to the UE.

5. The method according to claim 1, wherein before the sending, by the MME, the first message to the server, the method further comprises:
receiving, by the MME, a seventh message that carries instruction information and that is sent by a base station, wherein the seventh message is used to notify the MME that the UE loses the connection to the network, and the instruction information instructs the MME to report to the server that the UE loses the connection to the network; or
receiving, by the MME, a subscription request sent by the server, wherein the subscription request is a request for the server to subscribe to a state of the UE of losing the connection to the network.

6. A method for connecting to a network, comprising:
receiving, by a server, a first message sent by a mobility management entity (MME), wherein the first message notifies the server that a user equipment (UE) loses a connection to the network; and
sending, by the server, a second message to the MME in response to determining that the UE needs to connect to the network by using a relay UE, wherein the second message is used to instruct the MME to perform a relay process.

7. The method according to claim 6, wherein before the sending, by the server, the second message to the MME, the method further comprises:
generating, by the server, a list of candidate relay UEs;
wherein the sending, by the server, the second message to the MME comprises:
sending, by the server, to the MME, the second message that carries the list of candidate relay UEs.

8. The method according to claim 7, wherein the first message comprises a cell identity (ID) of the UE, and the generating, by the server, the list of candidate relay UEs comprises:
sending, by the server, an acquiring request to a gateway mobile location center (GMLC), wherein the acquiring request comprises an ID and the cell ID of the UE;
receiving, by the server, a request reply message sent by the GMLC, wherein the request reply message comprises one or more of: an ID of a candidate relay UE that is located in a same cell as the UE and that relays the UE, and an ID of a candidate relay UE that is located in a neighboring cell of a cell in which the UE is located and that relays the UE; and
generating, by the server, the list of candidate relay UEs according to content of the request reply message, wherein the list of candidate relay UEs comprises one or more of: the ID of the candidate relay UE that is located in the same cell as the UE and that relays the UE, and the ID of the candidate relay UE that is located in the neighboring cell of the cell in which the UE is located and that relays the UE.

9. The method according to claim 6, wherein after sending, by the server, the second message to the MME, the method further comprises:
receiving, by the server, after the UE connects to a network, an eighth message that carries an ID of a selected relay UE and is sent by the UE, wherein the eighth message notifies the server that the UE has connected to the network; and
sending, by the server to the MME, a fifth message that carries the ID of the selected relay UE, wherein the fifth message instructs the MME to send a sixth message to a UE other than the selected relay UE in the list of candidate relay UEs, and the sixth message instructs the UE other than the selected relay UE in the list of candidate relay UEs to stop sending a fourth message to the UE.

10. The method according to claim 6, wherein before the receiving, by the server, the first message, the method further comprises:
sending, by the server, a subscription request to the MME, wherein the subscription request is a request for the server to subscribe to a state of the UE of losing the connection to the network.

11. An apparatus for connecting to a network, comprising:
a sending module, configured to send a first message to a server, wherein the first message notifies the server that a user equipment (UE) loses a connection to the network;
a receiving module, configured to receive a second message sent by the server, wherein the second message instructs an acquiring module and the sending module to perform a relay process; and
the acquiring module, configured to acquire a list of candidate relay UEs that relay the UE,
wherein the sending module is further configured to send a third message to a candidate relay UE in the list of candidate relay UEs, wherein the third message instructs the candidate relay UE in the list of candidate relay UEs to send a fourth message to the UE, and the fourth message is used by the UE to determine a selected relay UE and connect to the network by using the selected relay UE.

12. The apparatus according to claim 11, wherein the acquiring module comprises:
an acquiring unit, configured to acquire one or more of: an identity (ID) of a candidate relay UE that is located in a same cell as the UE and that relays the UE, and an ID of candidate relay UE that is located in a neighboring cell of a cell in which the UE is located and that relays the UE, and provide an acquiring result for a generating unit; and
the generating unit, configured to generate the list of candidate relay UEs according to the acquiring result provided by the acquiring unit, wherein the list of candidate relay UEs comprises one or more of: the ID of the candidate relay UE that is located in the same cell as the UE and that relays the UE, and the ID of the candidate relay UE that is located in the neighboring cell of the cell in which the UE is located and that relays the UE.

13. The apparatus according to claim 12, wherein the first message comprises a cell ID of the UE, and the second message comprises the list of candidate relay UEs that relay the UE; and
the acquiring module is further configured to acquire the list of candidate relay UEs from the second message.

14. The apparatus according to claim 11, wherein:
the receiving module is further configured to receive a fifth message that carries an ID of the selected relay UE and that is sent by the server, wherein the fifth message instructs the sending module to send a sixth message to a candidate relay UE other than the selected relay UE in the list of candidate relay UEs, and the sixth message instructs the candidate relay UE other than the selected relay UE in the list of candidate relay UEs to stop sending the fourth message to the UE; and
the sending module is further configured to send the sixth message to the candidate relay UE other than the selected relay UE in the list of candidate relay UEs.

15. The apparatus according to claim 11, wherein:
the receiving module is further configured to receive a seventh message that carries instruction information and that is sent by a base station, wherein the seventh message notifies the apparatus that the UE loses the connection to the network, and the instruction information instructs the sending module to report to the server that the UE loses the connection to the network; and
the receiving module is further configured to receive a subscription request sent by the server, wherein the subscription request is a request for the server to subscribe to a state of the UE of losing the connection to the network.
